(19) United States
(12) Patent Application Publication
(10) Pub. No.: US 2009/0074390 A1
(43) Pub. Date: Mar. 19, 2009

(54) FLAME EFFECT APPARATUS

(76) Inventors: Patrick Virgilius Power, County Waterford (IE); Anthony Gunn, County Laois (IE); Edward Duggan, County Waterford (IE)

Correspondence Address: HOLLAND & KNIGHT LLP, 10 ST. JAMES AVENUE, 11th Floor, BOSTON, MA, 02116-3889, US

(21) Appl. No.: 11/855,656

(22) Filed: Sep. 14, 2007

(51) Int. Cl. F24D 13/00; G09F 19/12

(52) U.S. Cl. 392/348; 40/428

(57) ABSTRACT

Apparatus for simulating a solid fuel flame includes a frame within which is mounted a screen. An enclosure is mounted below the screen having a frosted glass refractor panel forming a top wall of the enclosure. A cylindrical container is rotatably mounted within the enclosure. A motor rotates the container on a support. The container is partially filled with a red or brown coloured liquid. Lamps or LED's within the enclosure are operable to shine light through the coloured liquid in the container and through the refractor panel onto the screen. Movement of the coloured liquid, which may be enhanced by internal projections in the container, causes flickering of the light projected onto the screen to give a flame effect simulating a solid fuel fire.

### BACKGROUND OF THE INVENTION

1. Field of the Invention

The present invention relates to an apparatus for simulating a solid fuel fire, and in particular to an apparatus for simulating a solid fuel fire that may be part of or embodied in a heating appliance such as an electric fire, gas fire or fan heater.

2. Description of the Related Art

It is known, for example, to provide such an apparatus comprising a source of light, simulated flame effect means for reflecting said light to simulate frames, simulated fuel means illuminated by the light source to simulate a bed of combusting fuel, and screen means to view an image of the simulated flames. Generally, such screen means is positioned between said flame effect means and said simulated fuel means. Very often, the screen means is capable of diffusely transmitting light reflected by the said flame effect means and also capable of reflecting light from the simulated fuel means so that the simulated flames means appear to emanate between the simulated fuel means and an image of the latter means reflected in said fuel means, such as described in UK Patent Specification No. 2230335. Another type of apparatus often used includes a translucent screen supported on a frame. The translucent screen is usually of a synthetic plastics material and a red lamp is mounted behind the screen to provide a light source. The light source may be directed from moving light reflecting elements onto the rear surface of the screen. The shadow of an irregularly shaped fuel simulating member may also be projected onto the rear surface of the screen. When the fire is in operation, the general effect on the front of the screen is of a partly illuminated area with dark fuel lumps at a lower edge thereof and upwardly moving flashes of light which simulate flames rising up the screen.

UK Patent Specification No. 1457540 describes another such device. The flame effect is provided by using a movable element between a screen and the light source. There are many other patents which describe various ways of producing a flickering light source.

Very often, there is suspended a flexible material disposed inwards of the viewing screen between a light source and the viewing screen. Usually, some means for causing an airflow is provided so that the suspended flexible materials flickers and moves in the air, thus imparting a flame effect.

However, none of these devices are particularly realistic in use and the present invention is directed towards providing an improved apparatus for simulating a solid fuel fire that will overcome some of the aforesaid problems.

### SUMMARY OF THE INVENTION

According to the invention there is provided an apparatus for simulating a solid fuel flame, including:
a screen;
   a liquid container having a sidewall at least portion of which is translucent;
said container being partially filled with a translucent liquid;
a light source positioned to direct light through the container onto the screen;
   a container support means for rotatably supporting the container; and
means for rotating the container on the container support means.

In a preferred embodiment a translucent refractor panel is mounted between the container and the screen.

In another embodiment the refractor panel is a frosted panel.

In another embodiment at least one face of the refractor panel has a roughened surface.

In a further embodiment at least one face of the refractor panel has an uneven surface.

In another embodiment the refractor panel is coloured.

In another embodiment the refractor panel is a glass panel.

In a further embodiment the container has a number of spaced-apart indentations in a sidewall of the container.

Preferably said indentations are randomly dispersed around the sidewall of the container.

In a preferred embodiment said indentations include a number of shallow indentations at translucent portions of the sidewall, said shallow indentations formed by cut-out grooves in the side wall of the container.

In another embodiment said indentations include deep indentations which project into an interior of the container.

Conveniently said deep indentations are formed by deformations in the sidewall of the container.

In another embodiment the container is cylindrical.

In another embodiment the container is formed from glass.

The sidewall of the container must be at least partially translucent to allow through passage of light and may be partially or fully transparent.

In a further embodiment the screen comprises a reflective plate mounted behind the container and extending upwardly above the container.

In a preferred embodiment the reflective plate has an upright lower portion located directly behind the container and an upper portion angled forwardly of the lower portion, said upper portion being located above the container.

In another embodiment the light source comprises one or more light emitting diodes (LED's).

In another embodiment the liquid is vinegar.

In another aspect the invention provides an electric fire including the flame simulating apparatus as described herein.

Conveniently the electric fire further includes an electric fan heater.

In another embodiment a plurality of inwardly directed projections are provided on an interior of the container wall.

Ideally, the container is partially filled with a coloured liquid. Preferably, the liquid is coloured brown or red.

In one embodiment of the invention, the projections are randomly arranged around the interior of the container. The projections may be of any suitable construction such as blades or the like, or may, for example, be provided by different pieces of a silicone material. Ideally, they are randomly arranged and are of different sizes. They perform two functions, namely, to obscure the light passing through the cylinder and to cause irregular movement of the liquid.

In another embodiment of the invention, additional translucent coloured portions are provided in the container wall. These, for example, can be blue, green and other colours, to simulate various different coloured flames. They may be provided by translucent patches affixed to the exterior of the container wall.

In another embodiment the container is slightly less than half full with liquid.

In a further embodiment the container is cylindrical and mounted so that its cylindrical wall is substantially horizontal.

### BRIEF DESCRIPTION OF THE DRAWINGS

The invention will be more clearly understood from the following description of some embodiments thereof, given by way of example only, with reference to the accompanying drawings, in which:

FIG. 1 is a front view of a fire embodying the apparatus of the invention with portion removed,

FIG. 2 is a typical sectional view along the line II-II of FIG. 1,

FIG. 3 is an exploded perspective view of another electric heater including flame effect apparatus of the invention,

FIG. 4 is a detail perspective view of portion of the apparatus of FIG. 3, and

FIG. 5 is a detail side sectional elevational view of portion of another apparatus of the invention.

### DESCRIPTION OF THE PREFERRED EMBODIMENTS

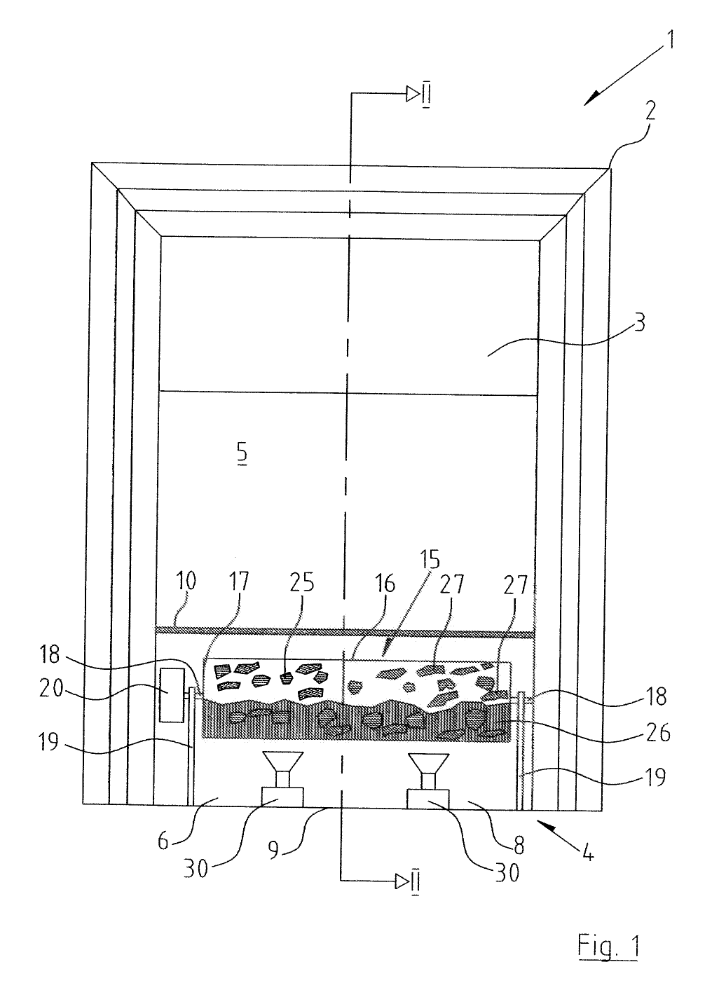

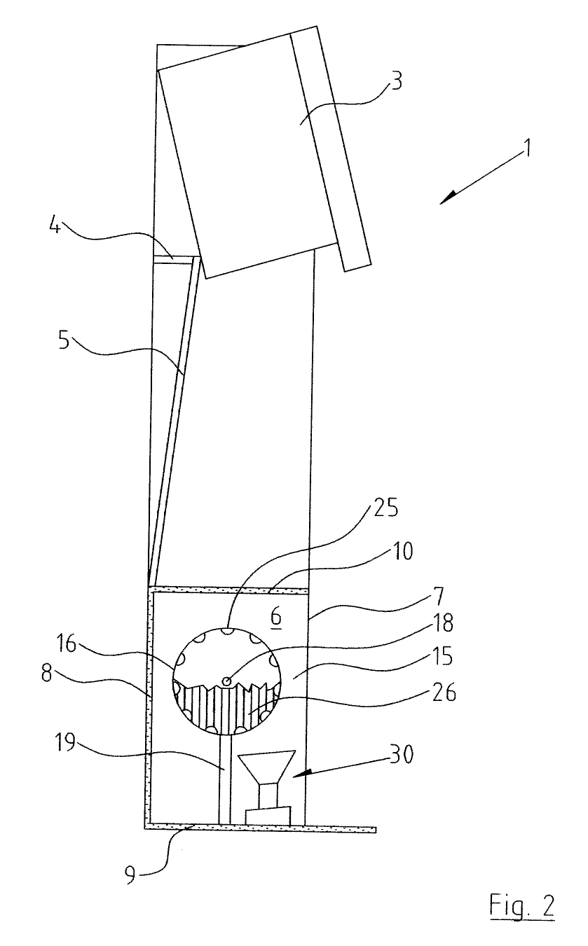

Referring to the drawings, and initially to FIGS. 1 and 2 thereof, there is illustrated an apparatus, indicated generally by the reference numeral 1, for simulating a solid fuel flame mounted within a fireplace 2 having a fire, in this case, an electric fan heater 3, mounted therein. There is further provided a frame 4 within which is mounted a screen 5 which can be of any suitable material and may, in fact, be white or some translucent material. Mounted below the screen 5 is an enclosure 6 having a front wall 7, rear wall 8 and base 9. It further includes a top wall 10, in this embodiment, of an opaque material, namely, frosted bubbly glass, that is to say, glass having a number or protrusions thereon.

Mounted within the enclosure 6 is a cylindrical container, indicated generally by the reference numeral 15, having a cylindrical wall 16 mounted between two end plates 17 in turn mounted on stub axles 18 which are rotatably mounted on supports 19. One of the stub axles 18 is driven by a motor 20. The cylindrical wall 16 is of a translucent material and mounts a plurality of inwardly directed projections 25 and is approximately half-filled with a coloured liquid, identified by the reference numeral 26. The coloured liquid, in this embodiment, is a reddish-brown colour and may conveniently be provided by vinegar.

The projections 25 are provided in this embodiment by lumps or blobs of silicone stuck to the inside of the container 15. Patches 27 of a translucent material, in this case, blue and green respectively, are affixed to the exterior of the cylindrical wall 16. Mounted beneath the container 15 are a pair of lamps 30 providing a light source.

In operation, the container 15 is rotated and the liquid 26 will move around the container 15 as it rotates and will be thrown into the interior of the container 15 and upwards and outwards generally in a confused manner by the projections 25. Thus, the light that will be delivered onto the screen 5 will flicker.

In addition to projections within the container 15, it is envisaged that flails or the like may be used, rather than projections, or indeed what are effectively liquid lifting blades, may be used to draw liquid up the container 15 as it is rotated, thus varying the pattern.

The protrusions, blades, flails or the like will be used as the container 15 rotates into and out of the path of the light. It is also envisaged that the background screen 5 may be of a translucent material.

It is envisaged that various means may be provided to vary the speed of rotation of the container 15 to further mimic a natural fire burning.

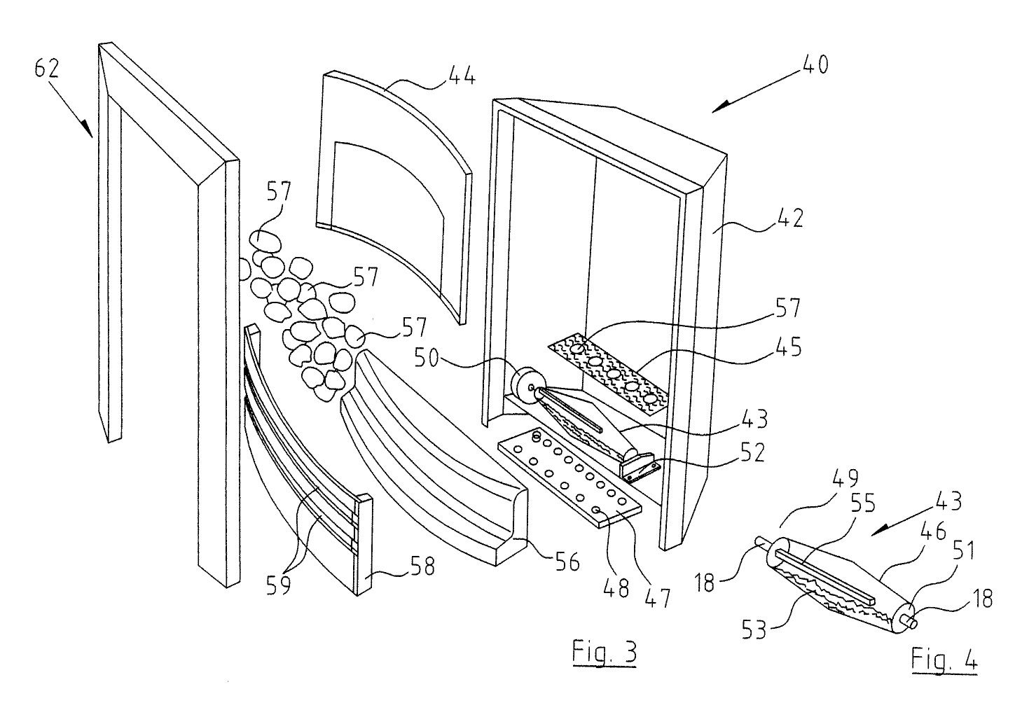

Referring now to FIGS. 3 and 4 there is shown another flame effect fire apparatus according to the invention indicated generally by the reference numeral 40. The apparatus 40 includes a frame formed by a metal housing 42 within is mounted a rotatable transparent container 43 partially filled with liquid. The container 43 is located beneath a screen reflector 44 mounted within the housing 42 at a rear portion of the housing 42 above the refractor panel 45. A refractor panel 45 is located between the container 43 and the screen reflector 44. A light panel 47 having a plurality of spaced-apart light emitting diodes 48 is mounted beneath the transparent container 43 for directing light through the container 43 and refractor panel 45 onto the screen reflector 44.

The transparent container 43 has a generally cylindrical sidewall 46 although as can be seen particularly in FIG. 4 it tapers inwardly somewhat between a central portion of the container 43 and each end of the container 43. An inner end 49 of the container 43 is connected to a drive motor 50 and an outer end 51 of the container 43 is rotatably supported on an associated mounting bracket 52. The container 43 is partially filled with a brown or red liquid 53 such as vinegar. An internal fin 55 agitates the liquid 53 when the container 43 is rotated by the electric motor 50.

A front panel 56 of transparent resin material is fitted in front of the container 43 and light panel 47 at a front of the housing 42. It will be noted that the front panel 56 is stepped to allow stacking of artificial coals 57 in between the front panel 56 and an associated grille 58 which mounts in front of the panel 56. A number of slots 59 in the grille 58 facilitate viewing of the artificial coals 57. The artificial coal pieces 57 can be made from coloured glass or translucent resin. A number of the artificial coals 57 are also mounted on top of the refractor panel 45.

The refractor panel 45 may be provided by a frosted glass panel.

A decorative frame 62 is mounted at a front of the housing 42 extending about the sides and top of the housing 42.

An electrical heating fan (not shown) is mounted at a top of the housing 42 as previously described.

In use, the light emitting diodes 48 are illuminated to direct light through the liquid 53 in the container 43 and through the refractor panel 45 onto the screen reflector 44. Movement of the liquid 53 within the container 43 provides a flickering flame effect on the screen 44. Some of the light emitting diodes 48 may be coloured red or blue to enhance the flame effect.

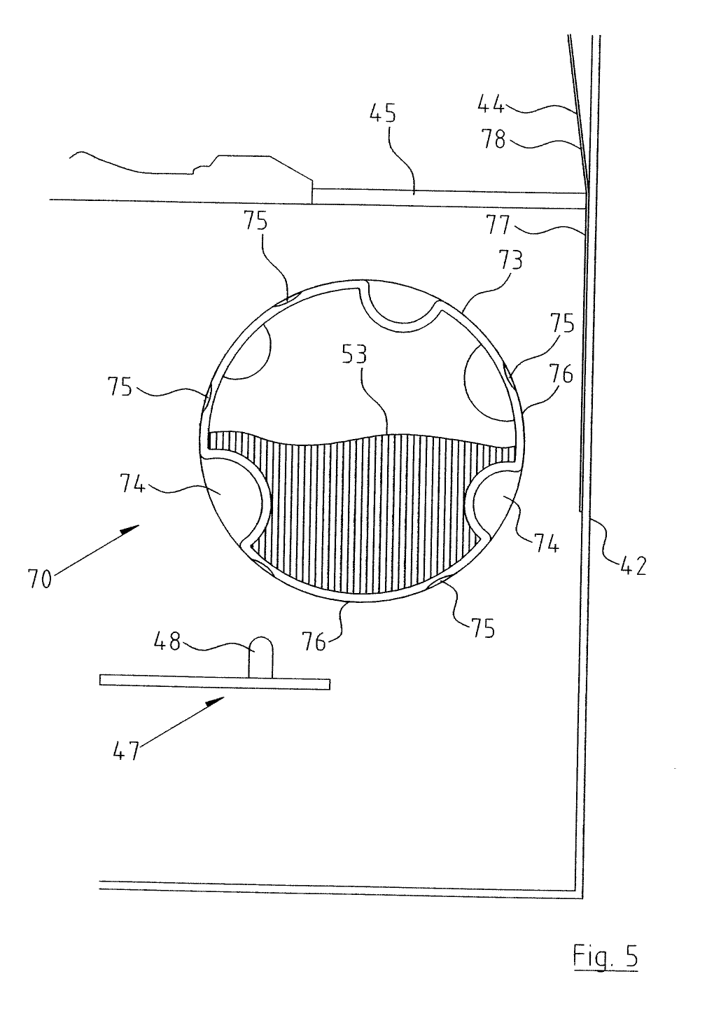

Referring now to FIG. 5 there is shown an alternative arrangement for the flame simulating apparatus indicated generally by the reference numeral 70. Parts similar to those described previously are assigned the same reference numerals. In this case a transparent cylindrical container 73 for the coloured liquid 53 is provided which has a number of randomly spaced-apart deep indentations 74 and shallow lens indentations or grooves 75 in a sidewall 76 of the container 73. The deep indentations 74 agitate the liquid 53 as the cylinder 73 rotates and the shallow lens indentations 75 enhance the random flickering effect as light passes through the side wall of the cylinder 73.

The screen reflector 44 has an upright lower portion 77 located directly behind the container 73 and an upper portion 78 angled forwardly of the lower portion 77 above the container 73 and refractor panel 45.

The apparatus of the invention provides a flame effect apparatus which simulates a natural fire. The apparatus may be provided on its own or may incorporate a heating apparatus such as an electric fan heater.

In the specification the terms “comprise, comprises, comprised and comprising” or any variation thereof and the terms “include, includes, included and including” or any variation thereof are considered to be totally interchangeable and they should all be afforded the widest possible interpretation and vice versa.

The invention is not limited to the embodiments hereinbefore described, but may be varied in both construction and detail within the scope of the appended claims.

1. An apparatus for simulating a solid fuel flame, including:
a screen;
a liquid container having a sidewall at least portion of which is translucent;
said container being partially filled with a translucent liquid;
a light source positioned to direct light through the container onto the screen;
a container support means for rotatably supporting the container; and
means for rotating the container on the container support means.

2. The apparatus as claimed in claim 1 wherein a translucent refractor panel is mounted between the container and the screen.

3. The apparatus as claimed in claim 2 wherein the refractor panel is a frosted panel.

4. The apparatus as claimed in claim 2 wherein at least one face of the refractor panel has a roughened surface.

5. The apparatus as claimed in claim 2 wherein at least one face of the refractor panel has an uneven surface.

6. The apparatus as claimed in claim 2 wherein the refractor panel is coloured.

7. The apparatus as claimed in claim 2 wherein the refractor panel is a glass panel.

8. The apparatus as claimed in claim 1 wherein the container has a number of spaced-apart indentations in a sidewall of the container.

9. The apparatus as claimed in claim 8 wherein said indentations are randomly dispersed around the sidewall of the container.

10. The apparatus as claimed in claim 8 wherein said indentations include a number of shallow indentations at translucent portions of the sidewall, said shallow indentations formed by cut-out grooves in the side wall of the container.

11. The apparatus as claimed in claim 8 wherein said indentations include deep indentations which project into an interior of the container.

12. The apparatus as claimed in claim 11 wherein said deep indentations are formed by deformations in the sidewall of the container.

13. The apparatus as claimed in claim 1 wherein the container is cylindrical.

14. The apparatus as claimed in claim 1 wherein the container is formed from glass.

15. The apparatus as claimed in claim 1 wherein the screen comprises a reflective plate mounted behind the container and extending upwardly above the container.

16. The apparatus as claimed in claim 15 wherein the reflective plate has an upright lower portion located directly behind the container and an upper portion angled forwardly of the lower portion, said upper portion being located above the container.

17. The apparatus as claimed in claim 1 wherein the light source comprises one or more light emitting diodes.

18. The apparatus as claimed in claim 1 wherein the liquid is vinegar.

19. An electric fire including the apparatus as claimed in claim 1.

20. The electric fire as claimed in claim 19 which further includes an electric fan heater.
